(19) United States
(12) Patent Application Publication
(10) Pub. No.: US 2020/0321731 A1
(43) Pub. Date: Oct. 8, 2020

(54) CONNECTOR

(71) Applicant: Sumitomo Wiring Systems, Ltd., Yokkaichi, Mie (JP)

(72) Inventors: Takeshi Misu, Yokkaichi, Mie (JP); Masato Kamemura, Yokkaichi, Mie (JP)

(21) Appl. No.: 16/957,422

(22) PCT Filed: Dec. 19, 2018
(86) PCT No.: PCT/JP2018/046738

§ 371 Date: Jun. 24, 2020

(30) Foreign Application Priority Data
Dec. 26, 2017 (JP) 2017-249634

(51) Int. Cl. H01R 13/639; H01R 13/64; H01R 13/627

(52) U.S. Cl. CPC H01R 13/639; H01R 13/6272; H01R 13/64

(57) ABSTRACT

A connector (10) includes a housing (20) to be connected to a mating housing (90), and a separate connection detecting member (60) to be mounted slidably on the housing (20) for connection assurance of the housing (20) and the mating housing (90). The connection detecting member (60) includes a detecting member-side contact surface (72) to be brought into contact with the housing (20) and resiliently displaceable second arms (78). The housing (20) includes a housing-side contact surface (30) to be brought into contact with the detecting member-side contact surface (72) and arm contacts (50) to be brought into contact with the arms (78). The arms (78) are in contact with the arm contacts (50) in a direction opposite to a direction from the detecting member-side contact surface (72) toward the housing-side contact surface (30).

### BACKGROUND

### Field of the Invention

This specification relates to a connector.

### Related Art

Japanese Unexamined Patent Publication No. 2012-64461 discloses a connector composed of a male connector, a female connector to be connected to the male connector and a CPA (Connector Position Assurance) slidably mounted outside the female connector. The CPA includes a cantilevered CPA lock.

If the male connector and the female connector are connected, a female lock of the female connector rides over a male beak of the male connector for locking. If the CPA is slid in a connecting direction in this state, the CPA lock rides over the female lock and the male beak. In this way, connection assurance is made.

The CPA is mounted slidably with respect to the female connector and generally rattles with respect to the female connector. However, the connection of the female connector and the male connector may be released if the CPA rattles to such an extent that the female lock rides over the male beak in a connection assured state.

### SUMMARY

A connector disclosed in this specification has a housing to be connected to a mating housing, and a separate connection detecting member to be mounted slidably on the housing for connection assurance of the housing and the mating housing. The connection detecting member includes a detecting member-side contact surface to be brought into contact with the housing and a resiliently displaceable arm. The housing includes a housing-side contact surface to be brought into contact with the detecting member-side contact surface and an arm contact portion to be brought into contact with the arm. The arm portion is in contact with the arm contact portion in a direction opposite to a direction from the detecting member-side contact surface toward the housing-side contact surface.

The contact of the arm of the connection detecting member with the arm contact portion of the housing in the direction opposite to the direction from the detecting member-side contact surface toward the housing-side contact surface restricts a displacement of the connection detecting member in a direction normal to the detecting member-side contact surface and prevents rattling of the connection detecting member. Note that, to prevent the rattling of the connection detecting member, the arm need not necessarily be in resilient contact with the arm contact portion, but may not be in contact therewith.

The arm and the arm contact portion may be displaced in directions to be brought closer to each other when sliding the connection detecting member on the housing. In this situation, the arm resiliently deflects to prevent the generation of such a dynamic friction resistance as to hinder a sliding movement between the arm and the arm contact portion. Thus, the connection detecting member can be slid smoothly.

Arms may be provided on both widthwise sides of the connection detecting member. The arms provided on the both sides of the connection detecting member contact the arm contact portions so that the connection detecting member can be mounted on the housing with less rattling as compared to the case where a single arm is provided on only one of the left and right sides.

A tip of the arm may resiliently contact the arm contact portion, and the housing-side contact surface may be pressed against the detecting member-side contact surface by a reaction force generated by the tip of the arm resiliently contacting the arm contact portion. Thus, the housing-side contact surface and the detecting member-side contact surface can be held reliably in contact.

According to the connector disclosed in this specification, it is possible to prevent the rattling of the connection detecting member.

### BRIEF DESCRIPTION OF THE DRAWING

FIG. 1 is a rear perspective view of a connector in an embodiment.

FIG. 2 is a front perspective view of the connector.

FIG. 3 is a plan view of the connector.

FIG. 4 is a back view of the connector.

FIG. 5 is a front view of the connector.

FIG. 6 is a front perspective view of a connection detecting member.

FIG. 7 is a rear perspective view of the connection detecting member.

FIG. 8 is an underside perspective view of the connection detecting member.

FIG. 9 is a rear perspective view of a housing.

FIG. 10 is a front perspective view of the housing.

FIG. 11 is a perspective view before the connection detecting member is mounted on the housing.

FIG. 12 is a perspective view in a state where the connection detecting member is at a pre-assembling position.

FIG. 13 is a back view in the state where the connection detecting member is at the pre-assembling position.

FIG. 14 is a section along A-A of FIG. 5 in a state where the connection detecting member is at a connection assurance position.

FIG. 15 is a section along A-A of FIG. 5 in a state where the connection detecting member is at a connection assurance release position.

FIG. 16 is a section along B-B of FIG. 5 in the state where the connection detecting member is at the connection assurance release position.

FIG. 17 is a back view in section at the position of second arm portions in the state where the connection detecting member is at the connection assurance release position.

FIG. 18 is a section along A-A of FIG. 5 during a separating operation in a first action.

FIG. 19 is a section along A-A of FIG. 5 during the separating operation in the first action.

FIG. 20 is a section along A-A of FIG. 5 after the completion of the separating operation in the first action.

FIG. 21 is a section along B-B of FIG. 5 after the completion of the separating operation in the first action.

FIG. 22 is a back view in section at the position of the second arm portions after the completion of the separating operation in the first action.

FIG. 23 is a section along A-A of FIG. 5 during a separating operation in a second action.

FIG. 24 is a section along A-A of FIG. 5 during the separating operation in the second action.

FIG. 25 is a section along A-A of FIG. 5 after the completion of the separating operation in the second action.

### DETAILED DESCRIPTION

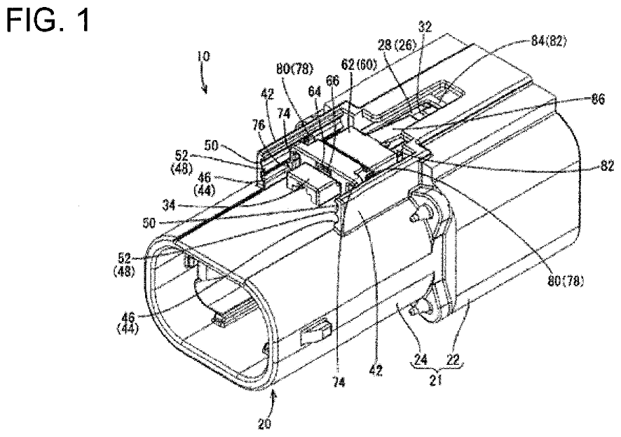

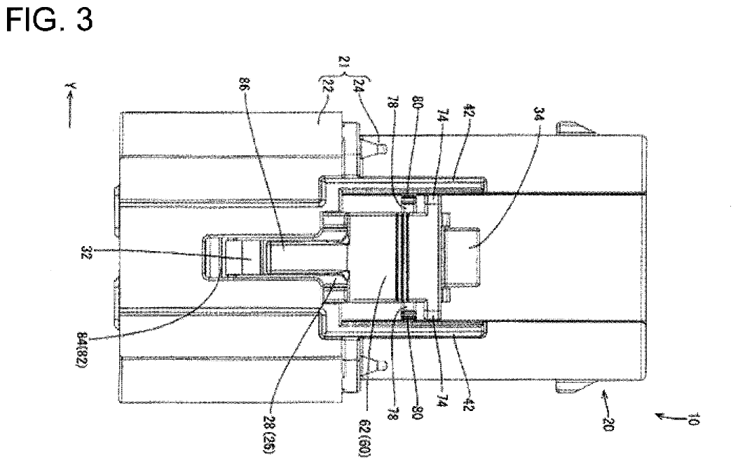

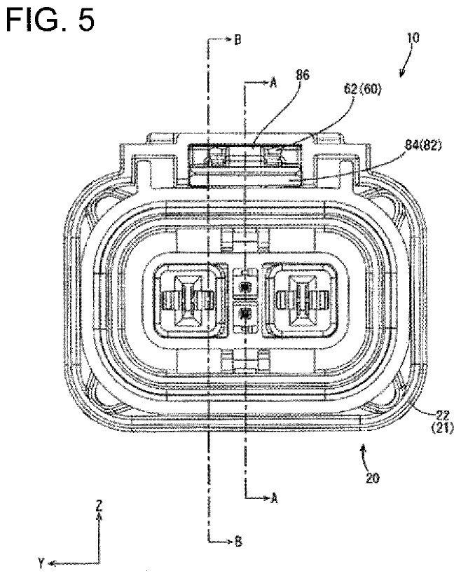

An embodiment is described with reference to FIGS. 1 to 25.

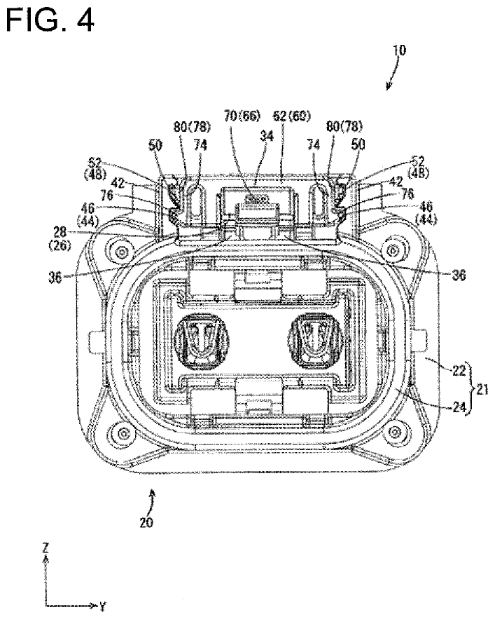

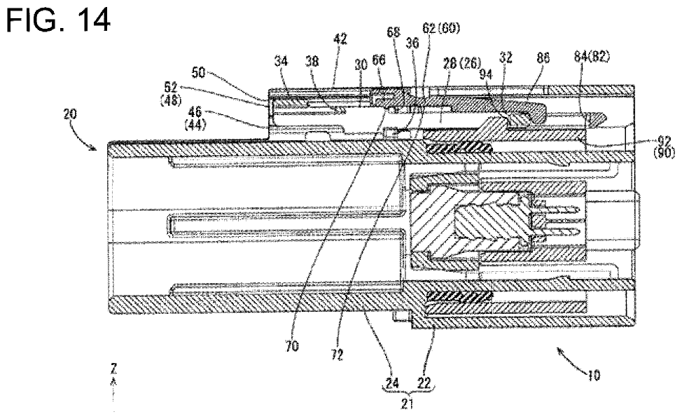

A connector 10 of this embodiment includes a female housing 20 and a connection detecting member 60 to be mounted slidably on the housing 20, as shown in FIG. 1. As shown in FIG. 14, the housing 20 is connected to a male mating housing 90. In the following description, a Z direction and a Y direction of FIG. 4 are referred to as an upward direction and a rightward direction, and a connecting direction of the housing 20 and the mating housing 90 is referred to as a forward direction.

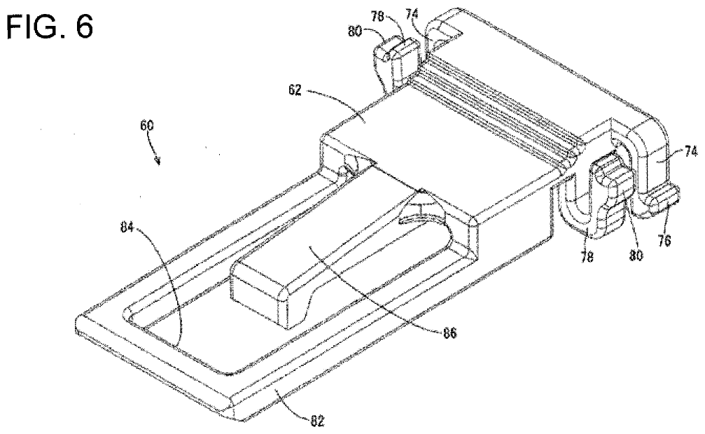

The connection detecting member 60 is for connection assurance by detecting that the housing 20 and the mating housing 90 are connected properly and is a functional member for realizing a so-called CPA (Connector Position Assurance). As shown in FIG. 6, the connection detecting member 60 includes a detecting member body 62 in the form of a rectangular plate, a frame-like latch 82 projecting forward from the front end of the detecting member body 62, and a connection detecting portion 86 cantilevered from the front end of the detecting member body 62. The front end surface in the frame of the latch 82 serves as a later-described latch lock 84 that contacts a mating lock 94 of the mating housing 90 while connection is being released.

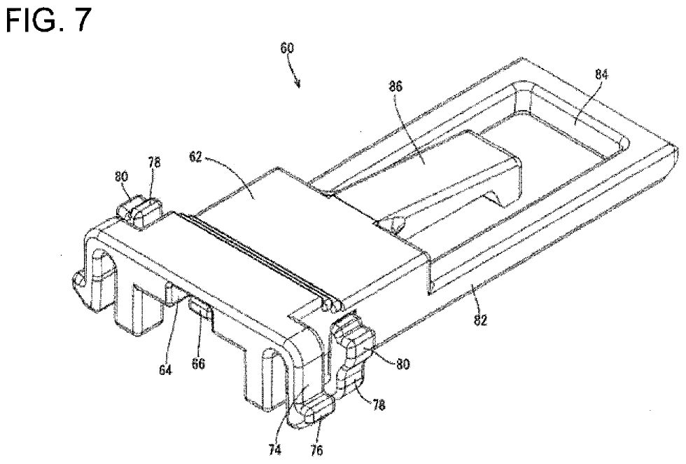

As shown in FIGS. 6 and 7, a flexible first arm 74 and a flexible second arm 78 is provided on each of the left and right sides of the detecting member body 62, with the second arms 78 being in front of the first arms 74.

As shown in FIGS. 6 and 7, the first arms 74 are cantilevered down from the both side parts of the detecting member body 62, and first claws 76 project laterally out on tip parts of the first arms 74.

As shown in FIGS. 6 and 7, the second arms 78 project down from both sides of the detecting member body 62 and are folded to project up. Further, second claws 80 projecting laterally out on tip parts of the second arms 78.

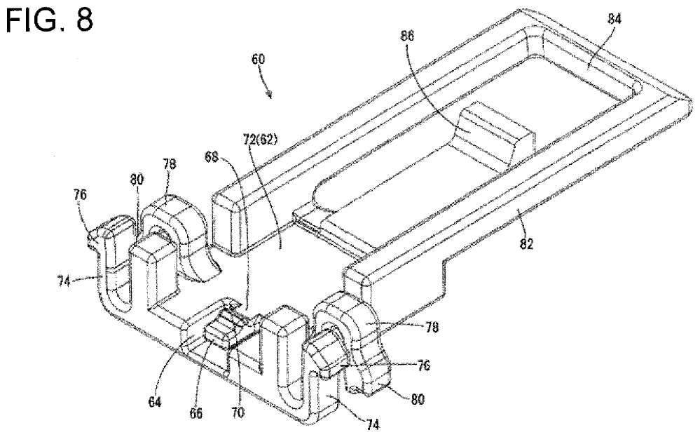

As shown in FIG. 8, a locking lance accommodation groove 64 is open in a rear part of the lower surface of the detecting member body 62, and a locking lance 66 is cantilevered rearward from the front inner wall of the locking lance accommodation groove 64. The locking lance 66 is flexible and resiliently displaceable in a vertical direction. The lower surface of the locking lance 66 serves as a sliding surface 68 that slides against the housing 20 to be described later, and a projection 70 projects down from the sliding surface 68.

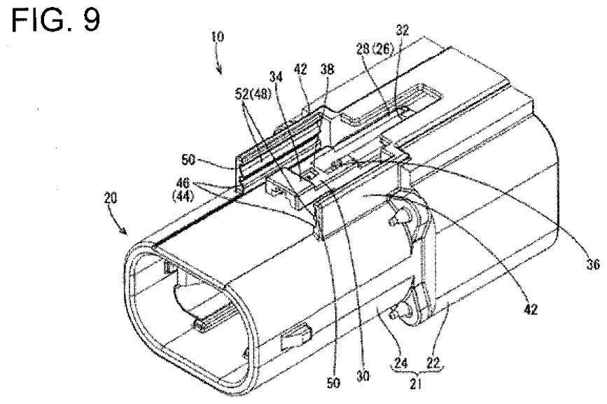

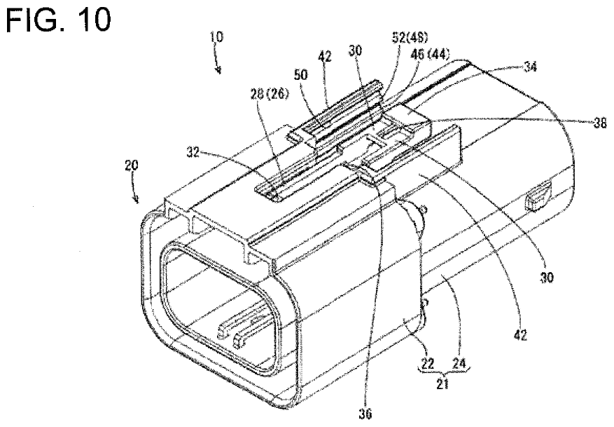

As shown in FIGS. 9 and 10, the housing 20 includes a receptacle 21 open forward and rearward. A lock arm 26 is provided on the upper surface of the receptacle 21 and left and right side walls 42 are provided on the upper surface of the receptacle 21.

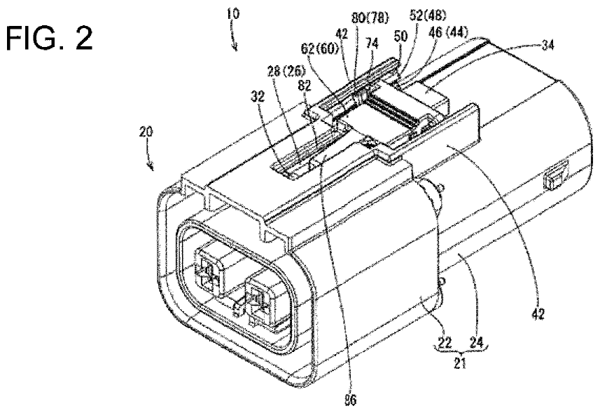

As shown in FIGS. 1 and 2, the receptacle 21 is composed of a front receptacle 22 open in a connecting direction and a rear receptacle 24 open in a direction opposite to the connecting direction.

As shown in FIG. 9, the lock arm 26 includes a lock arm body 28 having a rectangular shape long in a front-rear direction and having a frame-like opening. A base end portion 36 projects down from the lower surface of the lock arm body 28 and is connected to the upper surface of the rear receptacle 24. A rectangular pressing portion 34 is provided in a rear part of the upper surface of the lock arm body 28. If the pressing portion 34 is pressed down with a finger, the lock arm 26 is displaceable in a seesaw manner with the base end 36 as a fulcrum.

As shown in FIG. 9, a locking portion 38 is provided immediately in front of the pressing portion 34 of the lock arm body 28 and has a rectangular opening. The tip of the frame-like opening of the lock arm body 28 serves as a housing-side lock 32 that contacts the mating lock 94 of the mating housing 90 to be described later. The connection detecting member 60 is mounted slidably on the upper surface of the lock arm body 28.

As shown in FIG. 9, the two side walls 42 project up from the upper surface of the rear receptacle 24 and are disposed laterally to the lock arm 26. Two first guide grooves 44 and two second guide grooves 48 are provided along a sliding direction (front-rear direction) of the connection detecting member 60 in surfaces of the side walls 42 facing each other. The second guide grooves 48 are disposed above the first guide grooves 44. The bottom surfaces of the first guide grooves 44 serve as first tapered surfaces 46 inclined toward the facing first guide grooves 44. Similarly, the bottom surfaces of the second guide grooves 48 serve as second tapered surfaces 52 inclined toward the facing second guide grooves 48.

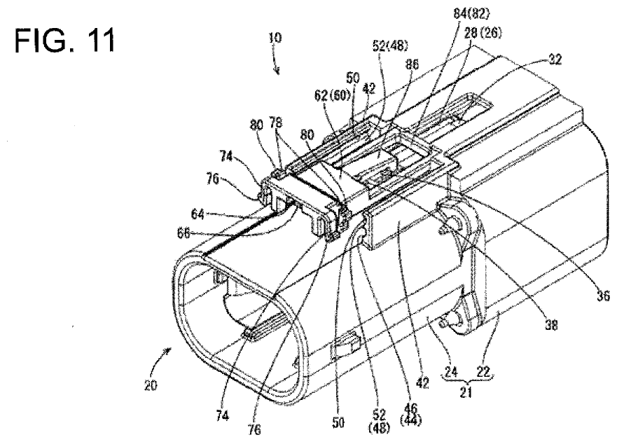

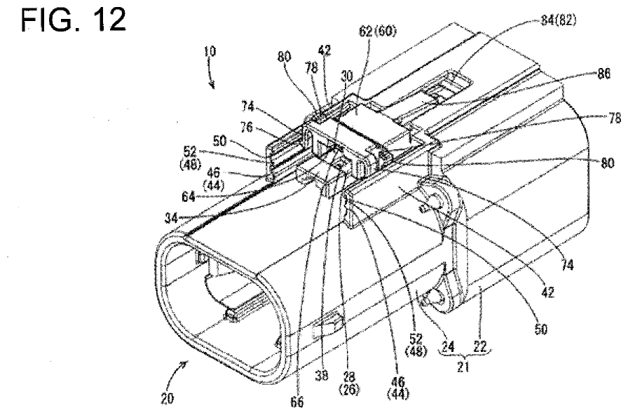

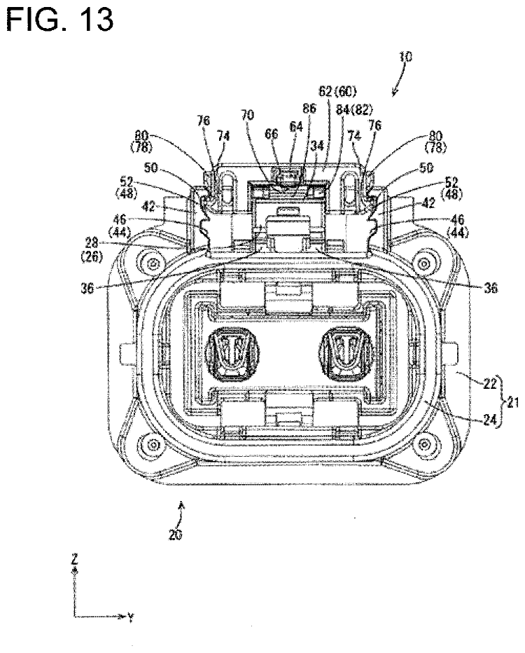

To mount the connection detecting member 60 on the housing 20, the first claws 76 of the first arms 74 of the connection detecting member 60 are inserted into the second guide grooves 48 of the side walls 42, as shown in FIGS. 11 and 12, and the connection detecting member 60 is mounted at a pre-assembling position shown in FIGS. 12 and 13.

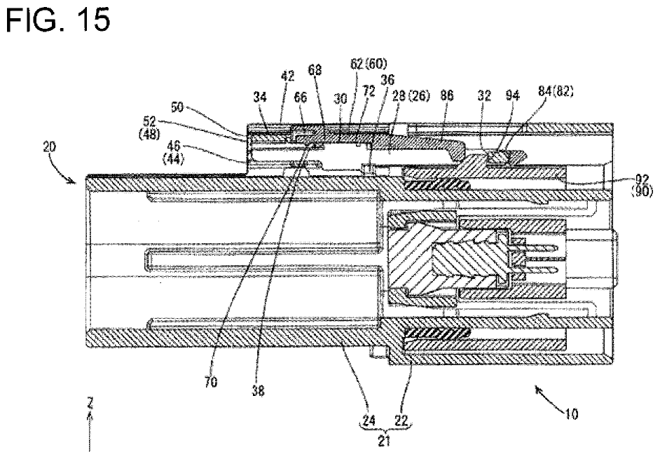

If the detecting member body 62 subsequently is pressed down, the first arms 74 slide against the second tapered surfaces 52 of the second guide grooves 48 to be deflected toward the facing first arms 74. Further, the second arm portions 78 slide against upper end parts of the side walls 42 to be deflected toward the facing second arms 78. In this way, the first arms 74 come out of the second guide grooves 48 and the lower surface of the pressed detecting member body 62 comes into contact with the upper surface of the lock arm body 28 to stop a downward displacement of the connection detecting member 60, and the connection detecting member 60 is positioned. At this time, as shown in FIG. 4, the deflected first arms 74 are restored and the first claws 76 enter the first guide grooves 44. Further, the deflected second arms 78 are restored and the second claws 80 enter the second guide grooves 48. Further, since the projection 70 of the locking lance 66 is located in the locking portion 38 and the projection 70 comes into contact with the inner wall of the locking portion 38 if the connection detecting member 60 is displaced in the connecting direction, the connection detecting member 60 is locked by the locking portion 38. This position is a later-described connection assurance release position of the connection detecting member 60 shown in FIGS. 1 and 15. In the above way, the connection detecting member 60 can be mounted on the housing 20.

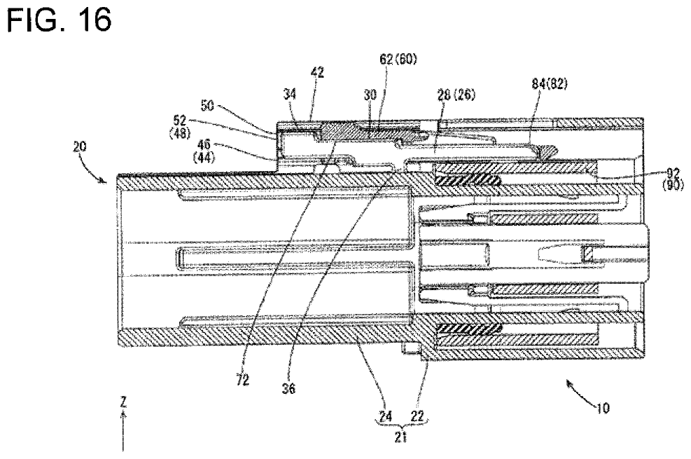

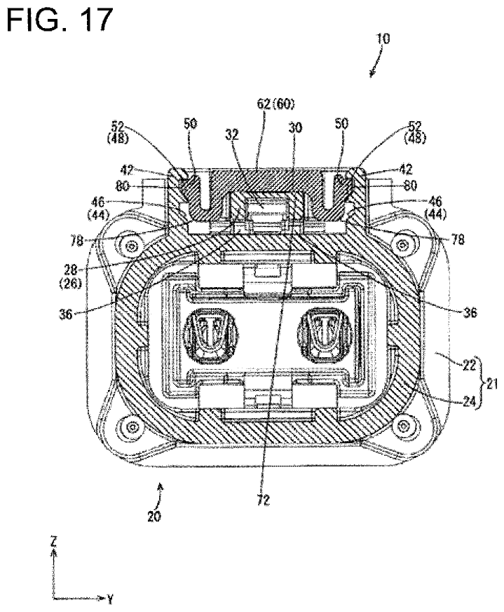

At the connection assurance release position, a housing-side contact surface 30, which is the upper surface of the lock arm body 28 of the housing 20, and a detecting member-side contact surface 72, which is the lower surface of the detecting member body 62 of the connection detecting member 60, are in contact, as shown in FIG. 16. Further, as shown in FIG. 17, the upper surfaces of the second claws 80 of the second arms 78 and arm contact portions 50, which are the ceiling surfaces of the second guide grooves 48 of the housing 20, are in contact. By this arrangement, a vertical displacement of the connection detecting member 60 is restricted and the rattling of the connection detecting member 60 is suppressed since the second arms 78 are in contact with the arm contact portions 50 of the housing 20 in a direction (upward direction) opposite to a direction from the detecting member-side contact surface 72 to the housing-side contact surface 30 (downward direction).

Further, the second claws 80 of the second arms 78 are resiliently in contact with the arm contact portions 50 of the second guide grooves 48, and the detecting member-side contact surface 72 presses the housing-side contact surface 30 by reaction forces from the second claws 80 of the second guide grooves 48. In this way, the housing-side contact surface 30 and the detecting member-side contact surface 72 reliably are held in contact.

As shown in FIG. 15, the mating housing 90 includes a mating receptacle 92 open in the connecting direction and the mating lock 94 projecting up from the upper surface of the mating receptacle 92.

If the housing 20 and the mating housing 90 are connected, the mating lock 94 is located forward of the housing-side lock 32 and the latch lock 84 in the connecting direction when viewed from the side of the housing 20, as shown in FIG. 15. In separating the mating housing 90 from the housing 20, the locking of the mating lock 94 and the housing-side lock 32 is released in a first action and, subsequently, the locking of the mating lock 94 and the latch lock 84 is released in a second action. In this way, the mating housing 90 is separated in two actions.

If the connection detecting member 60 is slid in the connecting direction with the housing 20 and the mating housing 90 connected and the connection detecting member 60 located at the connection assurance release position shown in FIG. 15, the projection 70 of the locking lance 66 is displaced resiliently up while coming into contact with and sliding against the inner wall of the locking portion 38. Thus, the projection 70 rides on the locking portion 38. Since the locking lance 66 is displaced resiliently if the projection 70 rides over the locking portion 38 in this way, a stress applied to the projection 70 when the projection 70 comes into contact with the inner wall of the locking portion 38 is reduced and the projection 70 can be prevented from being scraped by repeatedly riding on the locking portion 38.

If the connection detecting member 60 is slid farther in the connecting direction, a tip of the connection detecting portion 86 rides over the mating lock 94 and the housing-side lock 32, as shown in FIG. 14. This position of the connection detecting member 60 is a connection assurance position. Further, when the connection detecting member 60 is slid, the second claws 80 of the second arms 78 slide against the arm contact portions 50 of the second guide grooves 48 and the second arms 78 are deflected in directions facing each other. In this way, the connection detecting member 60 can be slid smoothly.

With the housing 20 and the mating housing 90 properly connected, the connection detecting member 60 can be displaced from the connection assurance release position shown in FIG. 15 to the connection assurance position shown in FIG. 14. On the other hand, in a state where the housings are not connected properly, the connection detecting member 60 cannot be displaced to the connection assurance position. For example, if the mating lock 94 is located below the housing-side lock 32, the connection detecting portion 86 comes into contact with the housing-side lock 32 even if the connection detecting member 60 is slid in the connecting direction. Thus, the connection detecting member 60 cannot be displaced to the connection assurance position.

The procedure of releasing the connection of the housing 20 and the mating housing 90 with the connection detecting member 60 located at the connection assurance position is described.

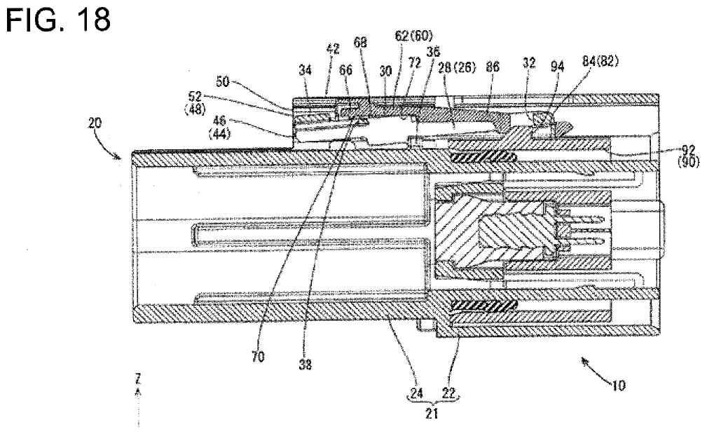

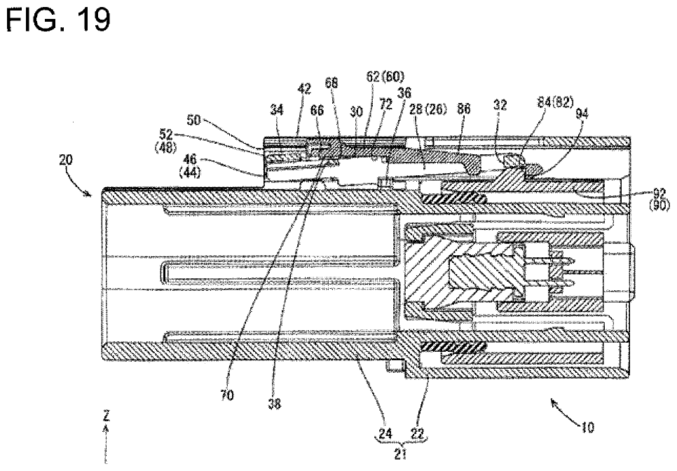

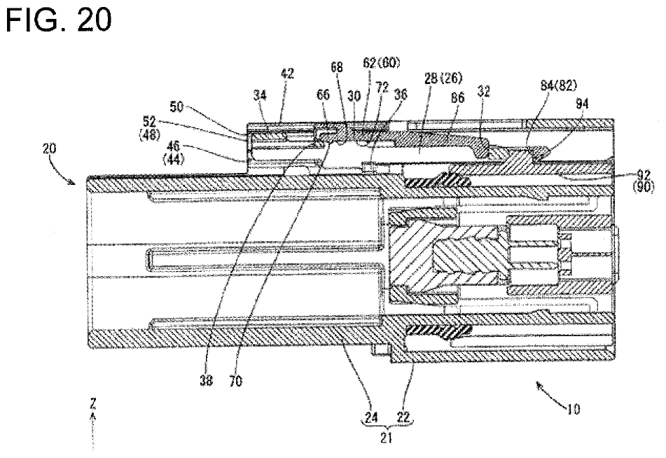

First, the connection detecting member 60 at the connection assurance position shown in FIG. 14 is pulled in the direction opposite to the connecting direction and set at the connection assurance release position shown in FIG. 15. If the pressing portion 34 of the lock arm 26 subsequently is pressed down, the housing-side lock 32 is displaced up, as shown in FIG. 18. If the mating housing 90 subsequently is pulled in the direction opposite to the connecting direction, the mating lock 94 comes into contact with the latch lock 84, as shown in FIG. 19. If the mating housing 90 subsequently is pulled farther in the direction opposite to the connecting direction, the mating lock 94 pulls the latch lock 84 and the connection detecting member 60 also is displaced in the same direction as the mating housing 90. In this way, the mating lock 94 is located between the housing-side lock 32 and the latch lock 84, as shown in FIG. 20, and the separation of the mating housing 90 in the first action is completed.

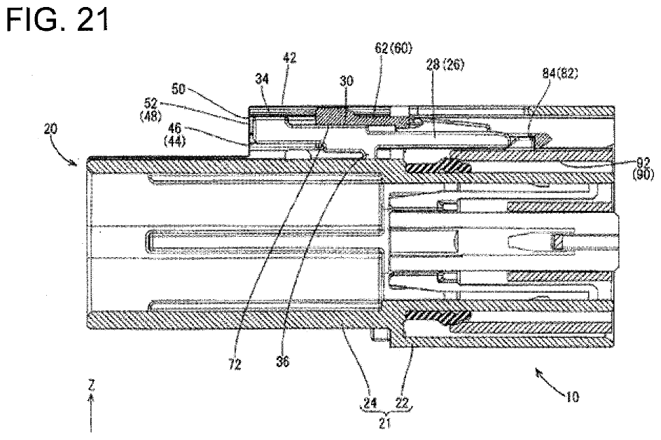

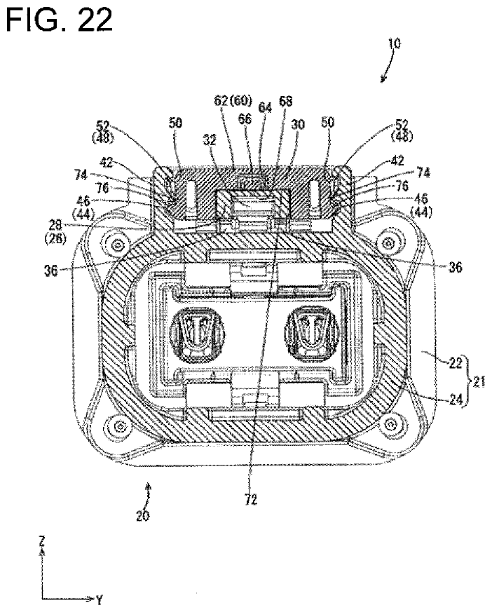

Also, when the separation in the first action is completed, the housing-side contact surface 30 and the detecting member-side contact surface 72 are in contact, as shown in FIG. 21, as at the connection assurance release position. Further, as shown in FIG. 22, the upper surfaces of the second claws 80 of the connection detecting member 60 and the arm contact portions 50, which are the ceiling surfaces of the second guide grooves 48 of the housing 20, are in contact. In this way, vertical rattling of the connection detecting member 60 is suppressed when the separation in the first action is completed. Thus, the latch lock 84 cannot be displaced up and the mating housing 90 is separated without the separating operation by the rattling of the connection detecting member 60.

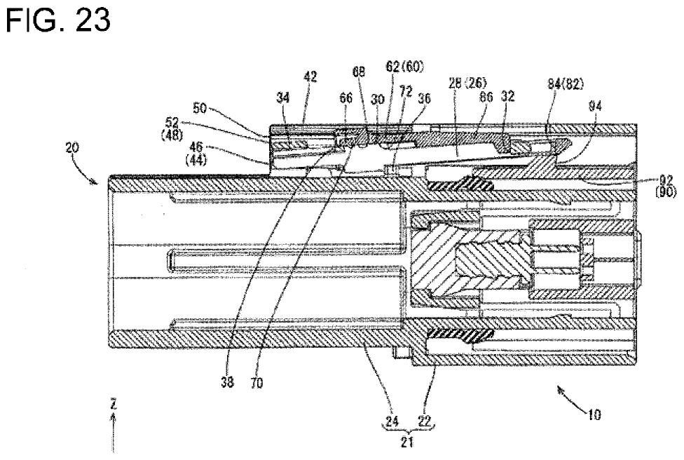

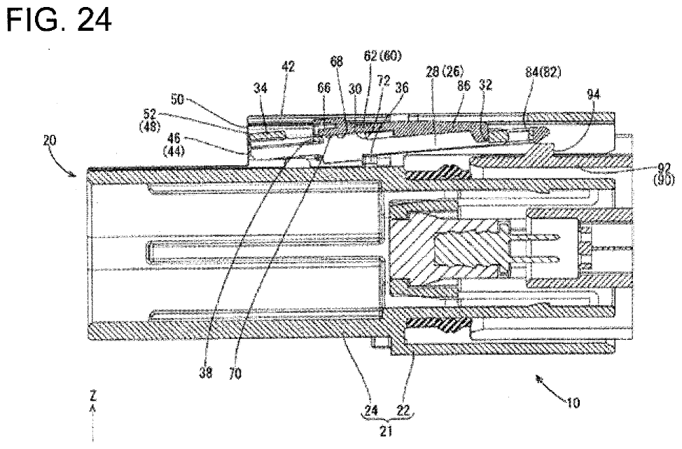

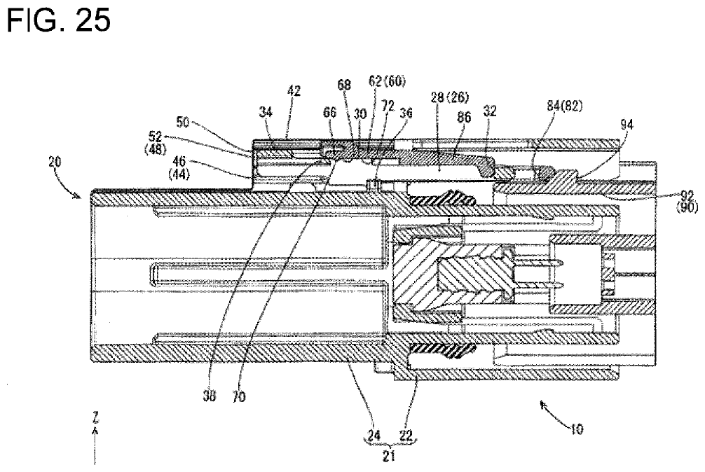

Subsequently, if the pressing portion 34 of the lock arm 26 is pressed, the latch lock 84 of the connection detecting member 60 also is displaced up together with the housing-side lock 32, as shown in FIG. 23. Subsequently, if the mating housing 90 is pulled in the direction opposite to the connecting direction, as shown in FIGS. 24 and 25, the separation of the mating housing 90 in the second action is completed.

As described above, according to this embodiment, since the second arms 78 of the connection detecting member 60 are in contact with the arm contact portions 50 of the housing 20 in the direction opposite to the direction from the detecting member-side contact surface 72 toward the housing-side contact surface 30, a displacement of the connection detecting member 60 in a direction normal to the detecting member-side contact surface 72 is restricted and the rattling of the connection detecting member 60 can be prevented. Note that, to prevent the rattling of the connection detecting member 60, the second arms 78 need not necessarily be in resilient contact with the arm contact portions 50, but may not be in contact therewith.

Further, even if the second arms 78 and the arm contact portions 50 are displaced in such directions as to be brought closer to each other in sliding the connection detecting member 60 on the housing 20, the second arms 78 are deflected resiliently to prevent the generation of such a dynamic friction resistance as to hinder a sliding movement between the second arms 78 and the arm contact portions 50. Thus, the connection detecting member 60 can be slid smoothly slid.

Further, the second arms 78 are provided on both side parts of the connection detecting member 60 and the second arms 78 contact the arm contact portions 50. Thus, the connection detecting member 60 can be mounted on the housing 20 with less rattling, as compared to the case where the second arm 78 is provided on only one of the left and right side parts.

Further, since the housing-side contact surface 30 is pressed against the detecting member-side contact surface 72 by reaction forces when the second claws 80 of the second arms 78 resiliently contact the arm contact portions 50, the housing-side contact surface 30 and the detecting member-side contact surface 72 can be held reliably in contact.

### Other Embodiments

The invention is not limited to the above described and illustrated embodiment. For example, the following various modes are also included.

Although the locking lance 66 is cantilevered rearward from the front inner wall of the locking lance accommodation groove 64 in the above embodiment, a locking lance may be cantilevered forward from the rear surface of a locking lance accommodation groove.

Although the connection detecting member 60 includes the latch 82 and the connection detecting portion 86 in the above embodiment, a connection detecting member may include no latch.

Although the second claws 80 of the second arms 78 are configured to resiliently contact the arm contact portions 50 of the second guide grooves 48 in the above embodiment, the second claws 80 of the second arms 78 may not be in contact with the arm contact portions 50 of the second guide grooves 48.

### LIST OF REFERENCE SIGNS

10 . . . connector
20 . . . housing
30 . . . housing-side contact surface
50 . . . arm contact portion
60 . . . connection detecting member
72 . . . detecting member-side contact surface
78 . . . second arm portion (arm portion)
80 . . . second claw portion (tip part)
90 . . . mating housing

1. A connector, comprising:
a housing to be connected to a mating housing; and
a separate connection detecting member to be slidably mounted on the housing for connection assurance of the housing and the mating housing,
wherein:
the connection detecting member includes a detecting member-side contact surface to be brought into contact with the housing and a resiliently displaceable arm,
the housing includes a housing-side contact surface to be brought into contact with the detecting member-side contact surface and an arm contact portion to be brought into contact with the arm, and
the arm is in contact with the arm contact portion in a direction opposite to a direction from the detecting member-side contact surface toward the housing-side contact surface.

2. The connector of claim 1, wherein the arm are provided respectively on both widthwise side parts of the connection detecting member.

3. The connector of claim 2, wherein:
a tip of the arm resiliently contacts the arm contact portion, and
the housing-side contact surface is pressed against the detecting member-side contact surface by a reaction force generated by the tip of the arm resiliently contacting the arm contact, portion.

4. The connector of claim 1, wherein:
a tip of the arm resiliently contacts the arm contact portion, and
the housing-side contact surface is pressed against the detecting member-side contact surface by a reaction force generated by the tip of the arm resiliently contacting the arm contact portion.
